(19) United States
(12) Patent Application Publication
(10) Pub. No.: US 2014/0278703 A1
(43) Pub. Date: Sep. 18, 2014

(54) ENTERPRISE RESOURCE MANAGEMENT SYSTEM AND METHOD

(71) Applicant: Pacific Gas and Electric Company, San Francisco, CA (US)

(72) Inventors: Crawford W. Owens, JR., Benicia, CA (US); Shayan Khodafar, Walnut Creek, CA (US); Melvin Duane Roush, Benicia, CA (US); Andrew Dale Alvis, Brentwood, CA (US); Fung Qing Yee, San Jose, CA (US); Kim Vu, Dublin, CA (US)

(73) Assignee: Pacific Gas and Electric Company, San Francisco, CA (US)

(21) Appl. No.: 14/214,601

(22) Filed: Mar. 14, 2014

Related U.S. Application Data
(60) Provisional application No. 61/799,354, filed on Mar. 15, 2013.

(51) Int. Cl. G06Q 10/06

(52) U.S. Cl. CPC G06Q 10/06313
USPC 705/7.23

(57) ABSTRACT

Some embodiments provide systems and methods of managing enterprise resources including providing a plurality of process modules for managing resources associated with a plurality of processes, at least one of the modules using at least one processor to access a database stored on a non-transitory computer-readable storage medium. Some embodiments include providing a project and asset management module for managing at least one step of a plurality of projects including long-term planning and defining at least one project work item in a project life cycle. Some embodiments also include a resource and scheduling module for maintaining a resource database stored on a non-transitory computer-readable storage medium and for scheduling project resources. Some embodiments include a planning and reporting module, an engineering design module, and an interface module that uses at least one of the processors to interface at least two of the plurality of modules.

### CROSS REFERENCE TO RELATED APPLICATIONS

This application claims the benefit of filing date of U.S. Provisional Application Ser. No. 61/799,354 titled “ENTERPRISE RESOURCE MANAGEMENT SYSTEM AND METHOD” filed on Mar. 15, 2013, the specification of which is incorporated by reference herein in its entirety.

### BACKGROUND

The management of technically complex projects from initial conception through planning, execution and completion, invariably requires the interaction of multiple personnel across a wide range of disciplines and managerial seniority. In most cases, project development will evolve through the assembly of large volumes of input data from various sources, most of which are manipulated and managed using many disparate systems and processes. Oftentimes, the software and systems that run it are disconnected, and require a high percentage of manual operation to exchange, assimilate, process and manage data. This complexity and lack of connectivity reduces the ability to accurately assess outcomes, and can minimize the ability of management to monitor execution efficiency. Furthermore, it may not be feasible to effectively monitor plan performance versus actual deliverable status, thereby hindering long-range financial planning

### SUMMARY

Some embodiments provide a computer-implemented method of managing enterprise resources comprising providing a plurality of process modules for managing resources within a project life cycle associated with a plurality of processes, where at least one of the modules uses at least one processor to access a database stored on a non-transitory computer-readable storage medium. The plurality of process modules includes a project and asset management module for managing at least a plurality of assets and regulating executable work for at least some of the plurality of projects, and a program management module for managing a substantially fully resourced schedule stored on a non-transitory computer-readable storage medium for at least some of the plurality of projects. The plurality of process modules includes a resource and scheduling module for maintaining a resource database stored on a non-transitory computer-readable storage medium and scheduling resources for at least some of the plurality of projects, and a planning and reporting module for planning and reporting upon at least some of the plurality of projects. The plurality of process modules includes an engineering design module for designing at least some of the plurality of projects, an interface module that uses at least one of the processors to interface at least two of the plurality of modules. The computer-implemented method of managing enterprise resources also comprises using at least the project and asset management module for long-term planning and defining at least one project work item in the project life cycle.

In some embodiments, the computer-implemented method of managing enterprise resources includes a program management module that is configured and arranged to maintain a schedule of at least one project work item during the project life cycle. In some further embodiments of the method, at least one project work item is automatically scheduled within the resource and scheduling module.

In some embodiments of the computer-implemented method of managing enterprise resources, all work impacting a construction phase of the project life cycle including any impact on construction, can be reviewed by construction management using the resource and scheduling module. In some further embodiments, the resource and scheduling module resource provides at least one of a resource management function, a Gantt chart function and a capacity summary function to provide resource loading information to a user.

Some embodiments of the computer-implemented method of managing enterprise resources can include an interface module that includes informational summary panes for providing information on a least one of the plurality of projects. The informational summary panes are at least one of a status pane, a team pane, a tasks pane, a drawings pane, a schedule pane, an operations pane, a components pane, a documents pane, a notes pane, a location pane, a hierarchy pane, a financial pane, another pane, and a forecast pane.

In some embodiments, the computer-implemented method of managing enterprise resources comprises a GIS module. In some embodiments of the computer-implemented method of managing enterprise resources, the GIS module is coupled to at least the interface module for identifying an address pinpoint corresponding to a job location of at least one project work item. In some further embodiments, the location pane includes at least one a map rendering at least partially illustrating a map that includes an address pinpoint corresponding to a job location of the at least one project work item.

In some embodiments, at least one of the information summary panes includes at least one data field dynamically linked to at least one of the plurality of modules. In some further embodiments, at least one of the information summary panes includes at least one data field dynamically linked to at least one warehouse management system module. In some other embodiments of the method, at least one of the information summary panes includes at least one data field dynamically linked to at least the program management module and the resource and scheduling module.

In some embodiments of the method, at least one of the information summary panes includes at least one audit history that is substantially non-erasable by a user. In some further embodiments, the interface module includes an informational summary pane comprising a resource allocation pane providing access to at least one of forecast data and operations summary data of the at least one project work item. In other embodiments, the resource allocation pane includes at least one data field dynamically linked to at least one database comprising an inventory of materials or supplies. In some embodiments, at least some portion of the at least one project work item comprises at least one available or planned assembly. Some additional embodiments include the planning and reporting module that includes an information window comprising at least one available assembly list and at least one planned assembly list.

In some embodiments of the computer-implemented method of managing enterprise resources, at least a portion of the project life cycle includes a target versus plan forecast based at least in part on at least one assembly selected from at least one of an available assembly list and a planned assemblies list. In some further embodiments, the planning and reporting module includes at least one financial planning window including financial forecasting data comprising target cost and plan cost. In some other embodiments, the target cost comprises baseline and adjusted target dollars and the plan cost comprises baseline and adjusted plan dollars.

In some embodiments, the planning and reporting module includes capacity versus demand reporting comprising at least one of a resource leveling window and a capital window and an expense window. Some other embodiments of the invention include the planning and reporting module that includes plan versus actual reporting. Some further embodiments of the planning and reporting module include resource leveling comprising at least one of a demand curve and a capacity curve. Some further embodiments of the planning and reporting module further include a demand scenario chart comprising an adjusted demand.

Some embodiments of the invention include a computer program product comprising a non-transitory computer readable storage medium having computer readable program code embodied therewith. The computer readable program code comprises a plurality of process modules for managing resources within a project life cycle associated with a plurality of processes, and which when loaded and run in a computer processor, causes the processor to provide a project and asset management module for managing at least a plurality of assets and regulating executable work for at least some of the plurality of projects. The processor is also caused to provide a program management module for managing a fully resourced schedule stored on a non-transitory computer-readable storage medium for at least some of the plurality of projects. The processor is also caused to provide a resource and scheduling module for maintaining a resource database stored on a non-transitory computer-readable storage medium and scheduling resources for at least some of the plurality of projects. Further, the processor is also caused to provide a planning and reporting module for planning and reporting upon at least some of the plurality of projects, and provide an engineering design module for designing at least some of the plurality of projects. Moreover, the processor is also caused to provide an interface module that uses at least one processor to interface at least two of the plurality of modules to define at least one project work item in the project life cycle, and to maintain a schedule of the least one project work item during the project life cycle, where the least one project work item is automatically scheduled within the resource and scheduling module.

Some embodiments include an enterprise resources management system comprising a processor, a non-transitory computer-readable storage medium in data communication with the processor including a plurality of process modules executable by the processor, and configured to manage resources within a project life cycle associated with a plurality of processes by performing steps executable by the processor. The steps include providing a project and asset management module for managing at least a plurality of assets and regulating executable work for at least some of the plurality of projects, providing a program management module for managing a fully resourced schedule stored on a non-transitory computer-readable storage medium for at least some of the plurality of projects, and providing a resource and scheduling module for maintaining a resource database stored on a non-transitory computer-readable storage medium and scheduling resources for at least some of the plurality of projects. The steps include providing a planning and reporting module for planning and reporting upon at least some of the plurality of projects, providing an engineering design module for designing at least some of the plurality of projects. The steps also include providing an interface module that uses the at least one processor to interface at least two of the plurality of modules to define at least one project work item in the project life cycle, and to maintain a schedule of the least one project work item during the project life cycle, where the least one project work item is automatically scheduled within the resource and scheduling module. In some embodiments of the enterprise resources management system, the interface module uses the at least one processor to calculate and display at least one informational summary panes including at least one of a status pane, a team pane, a tasks pane, a drawings pane, a schedule pane, an operations pane, a components pane, a documents pane, a notes pane, a location pane, a hierarchy pane, a financial pane, an other pane, and a forecast pane.

### DESCRIPTION OF THE DRAWINGS

FIG. 1 illustrates system modules that can be in the enterprise resource management system according to one embodiment of the invention.

FIG. 2A shows one example of a system implementation of the enterprise resource management system according to one embodiment of the invention.

FIG. 2B shows one example of a system architecture implementation of the enterprise resource management system according to one embodiment of the invention.

FIG. 3 shows a flow diagram illustrating data flow among system modules of the enterprise resource management system according to one embodiment of the invention.

FIG. 4 illustrates a flow diagram showing system integration links and connectivity between various processes across system modules in the enterprise resource management system according to one embodiment of the invention.

FIG. 5 shows a screenshot illustrating an example of a program management module portal according to one embodiment of the invention.

FIG. 6 shows a screenshot illustrating an example of a project management module portal of a according to one embodiment of the invention.

FIG. 7 shows a screenshot illustrating an example of a click module portal according to one embodiment of the invention.

FIG. 8A shows a screenshot illustrating an example of a status portal of a front end module according to one embodiment of the invention.

FIG. 8B shows a screenshot illustrating an example of a search order portal of a front end module according to one embodiment of the invention.

FIG. 9 shows a screenshot illustrating an example of a team portal of a front end module according to one embodiment of the invention.

FIG. 10A provide a screenshot illustrating an example of a task portal of a front end module according to one embodiment of the invention.

FIG. 10B provides a screenshot illustrating an example of a task portal of a front end module according to one embodiment of the invention.

FIG. 11 shows a screenshot illustrating an example of a drawings portal of a front end module according to one embodiment of the invention.

FIG. 12 shows a screenshot illustrating an example of a schedule portal of a front end module according to one embodiment of the invention.

FIG. 13 shows a screenshot illustrating an example of a schedule portal of a front end module according to one embodiment of the invention.

FIG. 14 provides a screenshot illustrating an example of an operations portal of a front end module according to one embodiment of the invention.

FIG. 15 provides a screenshot illustrating an example of an operations portal of a front end module according to one embodiment of the invention.

FIG. 16 shows a screenshot illustrating an example of a components portal of a front end module according to one embodiment of the invention.

FIG. 17 shows a screenshot illustrating an example of a documents portal of a front end module according to one embodiment of the invention.

FIG. 18 shows a screenshot illustrating an example of a notes portal of a front end module according to one embodiment of the invention.

FIG. 19 shows a screenshot illustrating an example of a location portal of a front end module according to one embodiment of the invention.

FIG. 20 shows a screenshot illustrating an example of a hierarchy portal of a front end module according to one embodiment of the invention.

FIG. 21 shows a screenshot illustrating an example of a financial portal of a front end module according to one embodiment of the invention.

FIG. 22 shows a screenshot illustrating an example of an “Other” portal of a front end module according to one embodiment of the invention.

FIG. 23 shows a screenshot illustrating an example of a resource allocation portal of a front end module according to one embodiment of the invention.

FIG. 24 shows a screenshot illustrating an example of a forecasting target versus plan portal of a front end CAEPS reporting module according to one embodiment of the invention.

FIG. 25 shows a screenshot illustrating an example of a forecasting capital versus cost portal of a front end CAEPS reporting module according to one embodiment of the invention.

FIG. 26 shows a screenshot illustrating an example of a forecasting capacity versus demand portal of a front end CAEPS reporting module according to one embodiment of the invention.

FIG. 27 shows a screenshot illustrating an example of a forecasting capacity versus demand portal of a front end CAEPS reporting module according to one embodiment of the invention.

FIG. 28 shows a screenshot illustrating an example of a forecasting capacity versus demand portal of a front end CAEPS reporting module according to one embodiment of the invention.

FIG. 29 shows a screenshot illustrating an example of a forecasting capacity versus demand portal of a front end CAEPS reporting module according to one embodiment of the invention.

FIG. 30 shows a screenshot illustrating an example of a forecasting capacity versus demand portal of a front end CAEPS reporting module according to one embodiment of the invention.

FIG. 31 shows a screenshot illustrating an example of a schedule versus capacity portal of a front end CAEPS reporting module according to one embodiment of the invention.

FIG. 32 shows a screenshot illustrating an example of a schedule versus capacity portal of a front end CAEPS reporting module according to one embodiment of the invention.

FIG. 33 shows a screenshot illustrating an example of a schedule versus capacity metrics portal of a front end CAEPS reporting module according to one embodiment of the invention.

FIG. 34 shows a screenshot illustrating an example of a schedule versus capacity metrics portal of a front end CAEPS reporting module according to one embodiment of the invention.

FIG. 35 shows a screenshot illustrating an example of a plan versus actual data portal of a front end CAEPS reporting module according to one embodiment of the invention.

FIG. 36 shows a screenshot illustrating an example of a plan versus actual data portal of a front end CAEPS reporting module according to one embodiment of the invention.

FIG. 37 shows a screenshot illustrating an example of a resource leveling portal of a front end CAEPS reporting module according to one embodiment of the invention.

FIG. 38 shows a screenshot illustrating an example of a resource leveling portal of a front end CAEPS reporting module according to one embodiment of the invention.

FIG. 39 shows a screenshot illustrating an example of a resource leveling portal of a front end CAEPS reporting module according to one embodiment of the invention.

FIG. 40 shows a screenshot illustrating an example of a supply chain portal of a front end CAEPS reporting module according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

Some embodiments of the invention can include a plurality of software system modules or sub-modules 11, 12, 13, 14a, 14b, 16, 18 including various programs for managing enterprise assets. For example, FIG. 1 illustrates system modules 11, 12, 13, 14a, 14b, 16, 18 that can form at least part of the enterprise resource management system 10 according to one embodiment of the invention. The enterprise resource management system modules 10 can comprise numerous software modules and/or firmware modules and platforms including at least one or more of the modules 11, 12, 13, 14a, 14b, 16, 18 that can, in some respects, be capable of asset management and resource planning. In some embodiments, the enterprise resource management system modules 10 can comprise numerous software modules and/or firmware modules and platforms including at least one or more of the modules 11, 12, 13, 14a, 14b, 16, 18 that can, in some respects, be capable of enabling enterprise-level visibility and management of all program work, through a project life cycle 83 from planning through operation. In some embodiments, the enterprise resource management system modules 10 can comprise numerous software modules and/or firmware modules and platforms including at least one or more of the modules 11, 12, 13, 14a, 14b, 16, 18 that can, in some respects, be capable of improving data accessibility and integrity, enabling preservation and enforcement of business processes, reducing duplication, and providing business process and project accountability.

In some embodiments, one or more of the system modules 10 can comprise a server-based enterprise software platform that can comprise numerous other modules and/or sub-modules. In some embodiments, one or more of the system modules 10 can function as a primary interface module between a user 40 and at least one other server-based enterprise software platform, including, but not limited to numerous modules and/or sub-modules 10.

In some embodiments, at least one of the enterprise resource management system modules 10 can be stored on at least one computing device 31 (for example, an enterprise-wide server system). Furthermore, in some embodiments, at least one of the enterprise resource management system modules 10 can be included as a non-transitory computer-readable medium having instructions capable of being executed by one or more processors 32.

As depicted in FIG. 2A, in at least one embodiment of the invention, the system modules 10 can form part of an enterprise resource management system 20. In some embodiments, one or more of the system modules 10 can be coupled to at least one data source and/or data storage system comprising one or more database 37. In some embodiments, the system modules 10 can be configured to send and receive data from at least one database 37 that can comprise at least one data storage 37b, and/or at least one data source 37a. Further, in some embodiments, the system modules 10 can be configured to receive data from at least one other source (e.g., as input data 39). In some further embodiments, at least one of the system modules 10 can be configured within the enterprise resource management system 20 to provide output data 25 to a user 40. For example, in some implementations, the at least one of the system modules 10 can be configured within the enterprise resource management system 20 to transmit output data 25 to at least one software or hardware platform outside of the system modules 10. In some embodiments, all data input 39 and data output 25 can flow through at least one of the system modules 10. For example, in some embodiments, the management system 20 can include a data output 25 comprising a click reporting 13a and a capital asset expense planning system reporting module 18a (hereinafter referred to as “CAEPS reporting module 18a”). Moreover, in some embodiments, all the system modules 10 are interconnected within the enterprise resource management system 20. In some embodiments, although the system can receive data from some other sources, the use of at least one of the system modules 10 enables data integrity across the enterprise resource management system 20.

FIG. 2B shows one example of a system architecture 30 implementation of the enterprise resource management system 20 according to one embodiment of the invention. As shown, the system architecture 30 can include at least one computing device 31, including at least one or more processors 32. Some processors 32 can include processors 32 residing in one or more server platforms. Some embodiments of the enterprise resource management system architecture 30 can include a network and application interface 35 coupled to a plurality of processors 32 running at least one operating system 34, coupled to at least one data source 37a, and at least one database 37 comprising at least one data storage device 37b, and at least one input/output device 37c.

In some embodiments, the invention can also be embodied as computer readable code on a computer readable medium 36. The computer readable medium 36 can be any data storage device that can store data, and which can thereafter be read by a computer system (such as computing device 31). For example, one or more of the system modules 10 can be configured to send and receive data from a computer readable medium 36 comprising at least one database 37 that can include at least one data storage 37b, and/or at least one data source 37a. Examples of the computer readable medium 36 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium 36 can also be distributed over a network so that the computer readable code can be stored and executed in a distributed fashion. For example, in some embodiments, one or more components of the system architecture 30 can be tethered to send and/or receive data (e.g., input data 39) through a local area network (LAN) 39a. In some further embodiments, one or more components of the system architecture 30 can be tethered to send or receive data (e.g., input data 39) through an internet 39b. In some embodiments, system modules 10, including enterprise applications 38, and one or more components of the system architecture 30 can be configured to be coupled for communication over a network 39a, 39b to received input data 39. In some embodiments, one or more components of the network 39a, 39b can include one or more resources for data storage, including any other form of computer readable media beyond the computer readable media 36 for storing information and including any form of computer readable media for communicating information from one electronic device to another electronic device. Also, in some embodiments, the network 39a, 39b can include wide area networks (WAN's), direct connections, such as through a universal serial bus (USB) port, other forms of computer-readable media, or any combination thereof. Also, various other forms of computer-readable media 36 can transmit or carry instructions to a computer, including a router, private or public network, or other transmission device or channel, both wired and wireless. In some embodiments, one or more components of the network 39a, 39b can include a number of client devices which can be personal computers, digital assistants, personal digital assistants, cellular phones, mobile phones, smart phones, pagers, digital tablets, laptop computers, Internet appliances, and other processor-based devices. In general, a client device (operable by a user 40) can be any type of external or internal devices such as a mouse, a CD-ROM, DVD, a keyboard, a display, or other input or output devices.

In some embodiments, the system architecture 30 as described can enable one or more users 40 to receive, analyze, input, modify, create and send data to the system architecture 30, including to and from one or more enterprise applications 38 operating on the system architecture 30. For example, some embodiments include at least one user 40 accessing one or more system modules 10, including at least one enterprise applications 38 via a stationary I/O device 37c through a LAN 39a. In some other embodiments, the system architecture 30 can enable at least one user 40 accessing one or system modules 10, including at least one enterprise applications 38 via a stationary or mobile I/O device 37c through an internet 39a. In some embodiments, the enterprise resource management system modules 10 can be configured as an enterprise resource management system 20 using at least the system architecture 30 depicted in FIG. 2B. Furthermore, in some embodiments, one or more of the system modules 10 can be further configured to enable one or more users 40 to select or define one or more of the system modules 10, or to interface with a plurality of other programs or data sources in a seamless manner.

FIG. 3 shows a flow diagram illustrating data flow and system module integration 50 amongst system modules 10 of the enterprise resource management system 20 according to one embodiment of the invention. Some embodiments of the enterprise resource management system 20 utilize one or more system modules 10 with interface connectivity depicted by arrows 51. Whereas some embodiments of the invention including the enterprise resource management system 20 are based on commercially available software systems, other system modules 10 can include one or more internally developed proprietary modules or sub-modules 10. For example, as shown in FIG. 3, some embodiments of the enterprise resource management system 20 can utilize one or more system modules 10 that perform project management including for example the program management module 11 (hereinafter referred to as “portfolio management module 11”). In some embodiments, the portfolio management module 11 can provide a variety of project management activities, including, but not limited to project work scope, work assignment to an employee or contractor (including for instance, assignment of a project management task to a project manager), and assessment of completion schedules. Furthermore, in some embodiments, the portfolio management module 11 can enable a variety of asset management activities that can be utilized by a user 40 (such as an asset management engineer) to identify work that needs to be completed at a specific work site.

Some embodiments of the enterprise resource management system 20 utilize one or more commercially available software systems, including, but not limited to a Primavera P6®, program management module 12. Primavera P6®, is a commercial project management software system, and Primavera P6®, is a registered trademark of Oracle and/or its affiliates. In some embodiments of the resource management system 20, the program management module 12 can enable a user 40 to plan, schedule, and control projects. In essence, the project management module 12 can provide a project management functionality to a user 40 for all project managed capital work. In some embodiments, the project management module 12 can maintain a fully resourced schedule with accurate dates. In some embodiments, the project management module 12 can be linked to other system modules 10 for sending and receiving information within the system 20. For example, as illustrated in FIG. 3, in some embodiments, the project management module 12 can be linked to the Maxavera® module 12a. Maxavera® is a registered trademark of Pipeline Group, Inc. Some embodiments utilize the Maxavera® module 12a substantially as a plug-and-play application to transform the project management module 12 from a stand-alone tool for project planning into a fully integrated planning & scheduling application.

In some embodiments, the Maxavera® module 12a can couple to other system modules 10. For example, in some embodiments, the Maxavera® module 12a can couple can couple to at least a SAP Warehouse management (WM) (referred to herein as warehouse management system module 14a), SAP Business Warehouse (BW) (referred to herein as business warehouse management system module 14b). SAP®, and the SAP® products mentioned therein are registered trademarks of SAP AG.

In some embodiments, the project management module 12 is linked to other modules for sending and receiving information, including the portfolio management module 11, and the warehouse management system module 14a (and front end module 16) via the Maxavera® module 12a, as well as the “CAEPS” module 18. The CAEPS module 18a can include highly modified software implementations built on at least one or more SAP® or similar software modules. The functional capabilities of the CAEPS module 18 include detailed order planning and reporting (through the CAEPS reporting module 18a) of plan metrics, for instance, capacity versus demand, plan versus actual amongst other plan statistical information. As shown, the system module integration 50 can enable the capability of integrated project planning and execution through the operation and interconnection of a plurality of system modules 10 (shown at least by arrows 51). For example, the enterprise resource management system module integration 50 includes warehouse management system module 14a, and an overlaid SAP® Workforce Scheduling and Optimization application (shown as clarity module 16, and hereinafter referred to as the “front end module 16”). Functioning with the resource management system 20, this module can enable the ability to assign resources and hours to operations on a per project basis over a set time (such as a work week). In some embodiments of the system 20, the front end module 16 provides the ability to plan, schedule, and control projects. For example, in some embodiments, the front end module 16 can maintain a fully resourced schedule with accurate dates. In some further embodiments, the front end module 16, functioning as a primary interface for the enterprise resource management system 20, can enable specific project management operations, and provide monthly financial, operations and resource forecast data.

In some embodiments, the warehouse management system module 14a with front end module 16 can function as a primary interface that can send and receive data from click module 13. In general, a user 40 can utilize the click module 13 to accomplish resource scheduling covering at least engineering design, construction and maintenance activities. For example, in some embodiments, weekly data can be sent to the click module 13. In some embodiments, supervisor capacity can be maintained, and project work can be automatically scheduled in the click module 13. Some embodiments provide data output functionality in the click module 13. As described earlier, some embodiments include a data output 25 that can include click reporting 13a. For example, in some embodiments, click reporting 13a functionality provides the ability to view and analyze resource loading for any specific project, or group of projects. In some embodiments, the interface connectivity (depicted by the arrows 51 shown between the system modules 10 in FIG. 3) can allow schedule and capacity data to be sent to business warehouse management system module 14b. In some embodiments, interface connectivity with the CAEPS reporting module 18a can enable the analysis of various project specific statistics, such as capacity versus demand, plan versus actual, schedule versus capacity metrics, as well as the ability to manipulate various project parameters to enable resource leveling.

FIG. 4 illustrates a flow diagram showing system integration links 82 and system process connectivity 84 between various project processes 86 across system modules 10 in the enterprise resource management system 20 according to one embodiment of the invention. As shown, a project life cycle 83 can be generally comprised of several phases, including at least a planning phase 85a, an engineering phase 85b, a staging phase 85c, a construction phase 85d, and a closeout phase 85e. In some embodiments, at least one of the system modules 10 can be used during at one of the phases 85a, 85b, 85c, 85d, 85e of the project life cycle 83. Furthermore, in some embodiments, at least one of the system modules 10 can be used within a plurality of the phases 85a, 85b, 85c, 85d, 85e occurring in serial or parallel. Further, as shown, the system integration and process map 80 can include system integration linkage 82 and system process connectivity 84 between the portfolio management module 11, the design engineering software platform module 19a, the project management module, the core modules 14a, 14b, and CAEPS module 18 on moving from the planning phase 85a through into the engineering phase 85b. In some embodiments, numerous detailed project planning, program management and design engineering processes include system integration links 82, and system process connectivity 84 prior to moving from the engineering phase 85b to one or more processes with the staging phase 85c, and the construction phase 85d. In some embodiments, the various system integration links 82 and system process connectivity 84 within these phases can include permitting, clearance, construction contracting and material readiness just prior to contractor management and construction and verification. In some embodiments, these processes can include various system modules 10 including the project management module 12, core modules 14a, 14b, and CAEPS 18, and click module 13. In some embodiments, the system integration linkage 82 and process linkage 80 can include system integration and process connectivity between the portfolio management module 11, the design engineering software platform module 19a, the project management module 12, the core modules 14a, 14b, the CAEPS module 18, and the click module 13. In some embodiments, the system integration and process map 80 can include system integration linkage 82 and system process connectivity 84 between at least one of the system modules 10 and the GIS module 19a on moving from the construction phase 85d to the closeout phase 85e. Furthermore, as depicted in FIG. 4, some embodiments of the invention include a plurality of system modules 10, all of which can maintain system integration linkage 82 and system process connectivity 84 as configured and deployed within the enterprise resource management system 20 within the enterprise resource management system architecture 30.

In general, various project processes 86 can fall within the general boundaries of a planning phase 85a category that can include long term planning process 90a, and advance authorization process 90b, each of which can be performed within the portfolio management module 11. In some embodiments, once a project proceeds through the authorization process 90b, the planning phase 85a can also include a project engineering process 90c at least a part of which is designed to assess the scope of the project. For example, in some embodiments, the project can move into a design engineering process 90d within the engineering phase 85b, or to a project engineering (scope) process 90c prior to entering the design engineering phase 90d. In some embodiments, upon moving from the engineering process 90c into the engineering phase 85b, in some embodiments, a design engineering process 90d can also include input from a detail project planning 90f.

As is common with most projects of even moderate complexity, the engineering phase 85b can involve some iterative processes with back and forth interactions between various processes. For example, some aspects of the detail project planning 90f can include two-way process connectivity with the project maintenance order project system process 90g, which can also include process connectivity with planning order management 90h, and BPC/PRJ (business planning and consolidation) 90i.

Furthermore, some processes in subsequent phases 86 can include iterative processes with back and forth interactions (i.e., the phases 85a, 85b, 85c, 85d, 85e of a project life cycle 83 oftentimes cannot be completely serial, and at least one phase that can occur concurrently with another phase). For example, the staging phase 85c and construction phase 85d can include one or more process that can include a two-way process connectivity to at least one other process within at least one other phase (for instance, the engineering phase 85b). In some embodiments, the staging phase 85c and construction phase 85d can include a clearance process 90j, a permitting process 90k, and a construction contracting 901. The clearance process 90j and permitting process 90k can be associated with project authorization 90e and design engineering 90d. In some embodiments, completion of the materials readiness process 90m can enable a scheduling process 90n followed by contractor management process 90o and construction processes 90p. In some embodiments, as a project transitions into a closeout phase, an ‘as-built’ verification process 90q coupled with a spatial reference process 90r can be completed prior to moving to closeout processes 90s, 90t, 90u within the closeout project phase 85e.

As shown and described earlier, some embodiments include additional system modules 10 to accomplish various aspects of a project life cycle 83. For example, some embodiments of the system modules 10 include a design engineering software platform module 19a. Bentley® refers to a CAD/CAM software platform such as Bentley Microstation®. Bentley® and Bentley MicroStation® are registered trademarks of Bentley Systems Inc, or Bentley Software Inc. Some further embodiments can also include a graphic work design 19c coupled with the design engineering software platform module 19a. In some embodiments, the module 19a can be used within the engineering phase 85b or during the construction phase 85d and/or closeout phase 85e. For example, in some embodiments, the platform module 19a can be used for a design engineering process 90d, and/or with an as-built verification 90q just prior to project closeout 90s, 90t, 90u.

In some embodiments, the project life cycle 83 can include one or more phase 85a, 85b, 85c, 85d, and 85e coupled with at least one source of geospatial information. For example, in some embodiments, the project life cycle 83 can include a “GIS” software platform 19b coupled with at least one other of the system modules 10 to provide geospatial information tied to at least one data component of the enterprise resource management system 20. The term “GIS” is well known in the art, and is an umbrella term which refers to a one or more software programs and/or databases 37 that can provide geographic information. In general, in some embodiments, by coupling at least one GIS software platform and/or database 37 to at least of the system modules 10, a user 40 can create, manage, analyze and display geospatial data and/or couple geospatial data with data output 25. Furthermore, in some embodiments, by coupling at least one GIS software platform and/or database 37 to at least of the system modules 10, a user 40 can couple at least one geospatial data variable with at least one aspect of a project phase 85a, 85b, 85c, 85d, 85e. For example, in some embodiments, at least one piece of geospatial information can be linked to and used within a plurality of project phases 85a, 85b, 85c, 85d, 85e through at least one of the system modules 10. For instance, in at least one embodiment, a user 40 can couple at least one geospatial data variable with at least one aspect of a project phase 85a, 85b, 85c, 85d, 85e using the front end module 16. In some embodiments, at least one piece of geospatial information can be linked to and used within a plurality of project phases 85a, 85b, 85c, 85d, 85e through the front end module 16.

In some embodiments of the enterprise resource management system 20, some system modules 10 can include at least one proprietary, non-commercial module or sub-modules, and/or one or more commercially available software systems. For example, FIG. 5 shows a screenshot illustrating an example of a portal 100 of a portfolio management module 11 according to one embodiment of the invention. As described earlier, the system module 10 can be configured within an enterprise resource management system 20 that can receive and create data. In some embodiments, the one or more system modules 10 can include methods to display and present data to a user 40, including for instance, a graphical user interface (hereinafter referred to as “GUI”). In some embodiments, the GUI can be rendered on any user 40 device that can include a display screen, including, but limited to a computer display (such as a terminal or monitor), a television, a projection display, or a mobile device such as a laptop, tablet, phone or PDA, or other mobile computer system. In some other embodiments, the GUI can be rendered onto any surface capable of being viewed by a user 40 (for example, a screen or wall used as a projection surface). In some embodiments, the user 40 can interact with the system 20 using any computer peripheral known in the art, including, but not limited to, a keyboard, a mouse, a pen-input device, a touch screen, a haptics device, a gesture device, or a voice-activated function hardware and/or software solution. In some embodiments, the user 40 can be provided with any option to modify the format of the GUI display, for example, to add or remove various functional components, or change the overall look and feel of the GUI display.

The portal 100 is one example of a GUI configured to communicate data to a user 40, and to serve as an input conduit for the system 20. In some embodiments, when configured as the enterprise resource management system architecture 30, the system 20 can receive and transfer data at to at least one of the system modules 10. As discussed earlier with respect to FIGS. 2A-3B, and 3, one or more of the system modules 10 can be coupled to at least one data source and/or data storage system comprising one or more database 37. The system modules 10 can be configured to send and receive data from at least one database 37, configured to receive data from at least one other source (e.g., as input data 39), and can be configured within the enterprise resource management system 20 to provide output data 25 to a user 40. As described earlier, the portfolio management module 11 enables a variety of asset and project management activities that can be utilized by a user 40. For example, using at least one embodiment of the portfolio management module 11 within the system architecture 30, a user 40 (for example, an asset management engineer) can be presented with the ability to identify work that needs to be completed at a specific work site. In some embodiments, the user 40 can then complete a questionnaire to identify a priority score for the work. In some further embodiments, the priority score is used to align the highest priority work with a capital portfolio target, and draw a cut-line to decide the portion of work that will be funded in any given fiscal year. In some embodiments, the portfolio management module 11 can be used to manage the completion of planning and authorizations for this work. In some other embodiments, the portfolio management module 11 can provide a variety of asset and project management activities, including, but not limited to, defining work project scope, creation of an executable work plan, initiation of a work assignment (i.e. assignment to a project manager), and creation of an assessment of completion schedule.

Some embodiments include at least one commercially available project management software system that is at least partially modified to function within the system 20 to allow seamless flow of data between the system modules 10. As described earlier, in some embodiments, such software systems can include project management module or similar systems. For example, FIG. 6 shows a screenshot illustrating an example of a portal 200 of a project management module 12 according to one embodiment of the invention. In some embodiments of the system 20, the project management module 12 can provide the ability to plan, schedule, and control projects. In some embodiments, the project management module 12 can send and receive information from one or more system modules 10 in the system 20. For example, as shown in the enterprise resource management system module integration 50 illustration in FIG. 3, in some embodiments, the project management module 12 is linked to other system modules 10 for sending and receiving information, including the portfolio management module 11, the warehouse management system module 14a (and front end module 16), as well as the CAEPS modules 18, 18a.

In some other embodiments of the invention, the project management module 12 can maintain a fully resourced schedule with accurate dates. In general, when initiating a new project, a project manager (i.e. a user 40) would be assigned to a project, and the project manager would log into the project management module 12 and use a project template to create a detailed project schedule with resources required and accurate milestone dates. In some embodiments, once a project manager saves the schedule data, it can be automatically transferred over to warehouse management system module 14a (and front end module 16). In some embodiments, the project manager can use the project management module 12 through a project life cycle 83 to maintain schedule and monitor progress. Furthermore, in some embodiments, the project manager can receive notifications from engineering and construction teams through the project management module 12 regarding changes to schedule dates and resources.

As described earlier, in some embodiments illustrated in FIG. 3, the warehouse management system module 14a with an integrated front end module 16 can send and receive data from click module 13. In some embodiments, this can include weekly project data sent to the click module 13. For example, FIG. 7 shows a screenshot illustrating an example of a portal 300 of a click module 13 according to one embodiment of the invention. Some embodiments provide data output functionality and automatic scheduling, and the review of resource loading in the click module 13. In some embodiments, all work impacting the construction phase 85d of the project life cycle 83 including construction 90p within any project can be sent to click module 13, and further, in some embodiments, specific work execution accountability for any aspect of any given project can be sent to the click module 13 and can be reviewed by construction management 90o. As shown in the illustration of the portal 300 in FIG. 7, in some embodiments, the click module 13 can include at least a task bar 302, a calendar function 304, a Gantt chart function 306, a task list 308, a scheduling function 310, resource management function 312, and a capacity summary function 314, as well as a business structure 316, amongst other functions. In some embodiments, task list 308 can enable a user 40 (for example a program manager or supervisor) to review the business structure 316, and schedule status and the target due date of any specific operation within the business, while scheduling can be accessed using the scheduling function 310. Furthermore, in some other embodiments, a user 40 can display a Gantt chart to visualize operations and schedules within any specific project using the Gantt chart function 306. In some further embodiments, a user 40 can review resource loading with the resource management function 312, and assess and maintain resource capacity using the capacity summary function 314.

In some embodiments, the enterprise resource management system 20 can provide the ability to ensure engineering design work and cost estimates are completed for funded work through resource and date commitments. In other embodiments, the enterprise resource management system 20 provides the ability to align specific engineering deliverables, including permitted deliverables by providing interconnectivity with any permitting work associated with any specific order and/or projects. The enterprise resource management system 20 can also allow visibility for materials/services required for funded work, and automate the materials and services requests for upcoming work once appropriate clearance is received through the enterprise resource management system 20. Furthermore, the system 20 can also provide information on construction work and costs estimates for funded work by linking resource and date commitments. In some embodiments, the system 20 can align construction deliverables, and automatically schedule resources when work is construction ready. Some embodiments also include the option to view capacity versus demand and resource loading for any specific project.

As described earlier, the embodiments shown in FIG. 3 illustrate at least one system and process connection with system modules 10, and as shown, the system module integration 50 can include a warehouse management system module 14a including a front end module 16 overlay. In some embodiments, the system module integration 50 can include one or more of the system modules 10 that can function as a primary interface between a user 40 and at least one other server-based enterprise software platform, including, but not limited to numerous modules and/or sub-modules 10. In some embodiments, the front end module 16 can serve as the primary interface module within the system module integration 50. In some embodiments, the front end module 16 can provide a user-friendly interface to SAP® core modules such as modules 14a, 14b, and can include a variety of portals enabling a user 40 to input, receive, analyze, and review data within the enterprise resource management system 20. In some embodiments, as depicted in FIG. 3, the system module integration 50 can include a plurality of system modules 10 coupled to the SAP-WM module 14a coupled to the front end module 16. In some embodiments, the front end module 16 can function as a primary interface to at least one of the plurality of system modules 10 when coupled to the SAP-WM module 14a.

In some embodiments, each of the system modules 10 can constitute software that can function independently on separate computer hardware platforms, or cooperatively, and in unison across separate but coupled computer platforms, or within a single computer hardware platform (for instance on a server system comprising the computing device 31). In some embodiments, each of the system modules 10 can function within the enterprise resource management system module integration 50. Some embodiments include the enterprise resource management system architecture 30 that can be implemented within the enterprise resource management system 50, including each of the system modules 10 that constitute software that can function independently, or cooperatively, and in unison within the system architecture 30. In some embodiments, the front end module 16 can function as a primary interface to at least one of the plurality of system modules 10 within the system architecture 30. In some embodiments, each of the system modules 10 that constitute software can function independently, within the system architecture 30, and the front end module 16 can function as a primary interface to at least one of the plurality of system modules 10 within the system architecture 30 in order to allow at least partial data pass-through from any one, or any one of a plurality of system modules 10 and the front end module 16. In essence, in some embodiments, the front end module 16 can function as a front end to at least one of the system modules 10, including the SAP-WM module 14a. Some embodiments include the front end module 16 that can be configured to display a variety of portals, including, but not limited to portals 400, 500, 600, 650, 700, 800, 850, 900, 950, 1000, 1100, 1200, 1300, 1400, 1500, 1600, 1700, 1800, and 1900. In some other embodiments, the front end module 16 can further include one or more portals configured for reporting data. For example, in some embodiments, the management system 20 can include a data output 25 comprising a click reporting 13a and a CAEPS reporting module 18a. In some embodiments, the CAEPS reporting module 18a, can comprise an output of data comprising a data representation of least portals 2000, 2100, 2200, 2300, 2400, 2500, 2600, 2700, 2800, 2900, 3000, 3100, 3200, 3300, 3400.

FIG. 8A for example shows a screenshot illustrating an example of a portal 400 “Status” of a front end module 16 according to one embodiment of the invention. As shown, the portal 400 can include a main tool bar 402 including various access icons 403, numerous function and access windows, such as a home window 402a, a close icon 402e (used, for instance to exit the front end module 16), a search window 402b, and the project maintenance order number window 402c. Some embodiments also include an edit function 402d, which can allow documents to be attached and associated with the order as shown in the project maintenance order number window 402c. In some embodiments, the access icons 403 can provide a convenient link to various information resources for display within the front end module 16, including, but not limited to the home function 403a, project maintenance order function 403b, a forecast function 403c, an engineering order search function 403d, an environmental record function 403e, a construction order search function 403f, a task management function 403g, and a reports tab 403h. Additionally, some embodiments can provide an information function 403i that can enable a user 40 to access links to job aids and other information within the front end module 16.

In some embodiments, a user 40 can search a project maintenance order from the portal 400 by selecting the search window 402b. FIG. 8B for example shows a screenshot illustrating an example of a portal 450 “search” of a front end module 16 according to one embodiment of the invention. As shown, the portal 450 can include a main tool bar 402 including various access icons 403, numerous function and access windows, such as the home window 402a and the search window 402b. In some embodiments, the portal 450 can display a search order window 455 including one or more order rows 457, and a set of search fields 460. As shown, the one or more order rows 457 can include an order number 470, a description 472, and a type 474. The search order window 455 can also display a user status 476, a system status 478, a MainWC (main work center) 480, and a location 482.

In some embodiments, a user 40 can review more details of a specific order from one or more order rows 457 by selecting and double-clicking at least one of the order rows 457 displayed in the search order window 455. In some embodiments, a user 40 can export one or more search screens using the export function icons 452. For example, in some embodiments, one or more search results displayed in the search order window 455 can be saved as an Adobe Acrobat® file or a Microsoft Excel® file. Adobe Acrobat® is a registered trademark of Adobe Systems, Incorporated. Microsoft Excel® is a registered trademark of Microsoft, Incorporated.

In some embodiments, a user 40 can also access various informational summary panes, covering various aspect of a project including, but not limited to, project engineering, construction, and permitting activities. Referring back to FIG. 8A, the various informational summary panes can include for instance, a status pane 410, a team pane 510, a tasks pane 610, a drawings pane 710, a schedule pane 810, an operations pane 910, a components pane 1010, a documents pane 1110, and a notes pane 1210. As shown, some embodiments also can include a location pane 1310, a hierarchy pane 1410, a financial pane 1510, an other pane 1610, and a forecast pane 1710. As shown in FIG. 8A, some panes can include access to other functions, and other windows and panes. For example, the status pane 410 can also include change status function 430, a project parameters display 432, as well as further informational windows including, but not limited to a warning flags window 435, and a project description window 440. Some embodiments also include access to further sub-panes. For example, the status pane 410 also can include access to an initiate pane 420, a design pane 422, a staging pane 424, a construction pane 426, and a closeout pane 428.

In some embodiments, the status pane 410 can provide a depiction of an informational status of any particular order, such as for example the order identified by the project number window 402c. In some embodiments, using the search window 402b, a user 40 can search for a project order as identified in the project maintenance order number window 402c. In some embodiments, the status pane 410 can also include a status information window 415. Some embodiments include a status information window 415 that can display a variety of status parameters including a status list 415a and a status description 415b, along with a set by LAN ID 415d, and a date set 415c. In some further embodiments, the project description window 440 can include a general summary, or further detailed information on the project related to the specific order linked to the specific project maintenance order number window 402c. In some embodiments, the warning flags window 435 can include a serious of alerts to provide users 40 with important and/or critical information concerning a project, including for example, a notification of tasks overdue, operation start date slippage and hours exceeded, etc.

Some embodiments can allow a user 40 to access information related to teams assigned to specific projects (e.g., any one team member involved with any of the phases 85a, 85b, 85c, 85d, 85e of the project life cycle 83). For example, in some embodiments, a user 40 can search for a specific team member using either known terms, or with the use of wildcards. In some other embodiments, a user 40 can change the position assignment of a team member, or add additional team members. For example, FIG. 9 shows a screenshot illustrating an example of a portal 500 “Team” of a front end module 16 according to one embodiment of the invention. The portal 500 can include a main tool bar 402 including various access icons 403, numerous function and access windows, 402a, 402b, and 402c. Some embodiments also include the edit function 402d, which within the portal 500 initiates a search mode. The team portal 500 can also include a team pane 510 including a team list 520 including a list of team member positions 522, and a list of names 524 assigned to positions 522. In some embodiments, one or more team members can include identifiers, such as a local area network identifier (hereinafter referred to as “LAN ID”). In some embodiments, a user 40 can initiate a search by selection of the edit function 402d, followed by making a selection in a LAN ID search field 525, and then entering a search term in the search term field 515a of the search name window 515 followed by selection of the search function 515b. In some embodiments, a user 40 can select a LAN ID within the position assignment field 530 to select for a specific position assignment. In some embodiments, team members without a LAN ID can also be assigned by an ID by entering their information.

Some embodiments can provide a portal 600 “Task” of a front end module 16 that can provide the user 40 with a list of tasks associated with any specific order, including further details of various sub-tasks. For example, FIG. 10A provide a screenshot illustrating an example of a portal 600 “Task” of a front end module 16 according to one embodiment of the invention. As shown, the portal 600 can include a main tool bar 402 including various access icons 403, numerous function and access windows, such as the home window 402a, search window 402b, and the project maintenance order number window 402c. Some embodiments also include the edit function 402d, which can allow documents to be attached and associated with the order as shown in the project maintenance order number window 402c. In some embodiments, the task pane 610 can include a task window 615 including a task list 620. The task list 620 can include at least one task associated with of any particular project order, such as for example the order identified by the project number window 402c. Using the search window 402b, a user 40 can search for a project order as identified in the project maintenance order number window 402c. In some embodiments, the task pane 610 can provide information of any specific task update, including, but not limited to task details, an identifier of the update, the date of the update, as well as a description of any specific task within the displayed task list 620. Moreover, in some embodiments, each field can be directly linked back to at least one other system module 10, including, but not limited to, any SAP® core or similar modules such as modules 14a, 14b, and one or more asset and project management modules including the project management module 12, and the portfolio management module 11.

In some embodiments, the task window 615 can also include a text field 622 that can include a short description associated with a task, an assigned field 624 and name field 628 including an assigned name and identifier information, and a search name field 626 can allow a user 40 to search for a team member assigned to any specific task. The task window 615 can also include task status and completion information with the due field 630, complete status field 632, complete on field 634, completed by field 636, and status field 638 data columns.

In some embodiments, a user 40 can also access various other informational summary panes and windows associated with various tasks. For example, the task pane 610 can also include a link 645 to an environmental task sub-pane or window. FIG. 10B for example shows a screenshot illustrating an example of a portal 650 “Task” of a front end module 16, that in some embodiments, can include one or more environmental tasks 660 displayed in the task pane 610. As shown, the user 40 can be provided with various parameters related to each environmental task 660, including task details, start and due dates, responsibility, status, etc. For example, the environmental record window 655 can include task details 662, task text 664 associated with the environmental tasks 660, as well as scheduling information including start date 666 and due date 668. The environmental record window 655 can also include a responsible or “resp” column 670, a search name 672, status 674, along with a completion by or “comp by” column 676, a completed on or “comp on” column 678, and a specific project maintenance order number 680 column. Furthermore, in some embodiments, direct links to numerous informational summary panes can be provided within the task pane 610, providing the user 40 the ability to efficient switch to informational summary panes that can contain information interrelated to any data displayed in the portal 650.

In general, as a project develops, various engineering drawings can be created and linked to at least one of the system modules 10. In some embodiments, any engineering document can be developed (e.g., using the Bentley® module 19a) using a variety of data sources, including for example data retrieved from data sources 37a, a computer readable medium 36, or from another source 39a, 39b. In some embodiments, once an engineering document is produced (at any time throughout a project life cycle 83), the document can be stored for access by the enterprise resource management system architecture 30, for example by saving to data storage 37b. In some embodiments, any engineering document (including any versions of the document), can be accessed through a portal 700 “Drawings” of a front end module 16. For example, as shown in FIG. 11, the portal 700 can include a main tool bar 402 including various access icons 403, numerous function and access windows, such as the home window 402a, search window 402b, and the project maintenance order number window 402c. In some embodiments, the drawings pane 710 can provide a depiction of an informational status of any particular project, such as for example the order identified by the project number window 402c. In some embodiments, the drawings pane 710 can include a drawings list window 715 that can provide access to various parameters associated with any specific drawing. For example, the drawings list window 715 can include a select box 718 for selecting any specific drawing within the drawings list window 715, along with some identifiers, such as the item number 720, code 722, and a drawing title 724. In some embodiments, the drawings list window 715 can also include a drawing type 726, a drawing number 728, a sheet number 730, and a revision number 732 associated with a distributed date 744. Some embodiments can also include forecast hours 734, an actual completion date 742, and a percent completion 740. The drawings list window 715 can also include comments 738, and some columns related to corrections, including a correction flag 746, and a forecast drawing correction incomplete date 748. In addition to a transmittal date 736 within the drawings list window 715, some embodiments also include an access to historical information associated with transmissions of drawings by access to a transmittal history window 770. Furthermore, in some embodiments, a user 40 can have access to various pending actions and/or historical parameters displayed as a calendar function 760.

Some embodiments of the invention can allow a user 40 to access one of more project schedules, and one or more scheduling access functions. For example, FIG. 12 shows a screenshot illustrating an example of a portal 800 “schedule” of a front end module 16 according to one embodiment of the invention. As shown, the portal 800 can include a main tool bar 402 including various access icons 403, and numerous function and access windows, such as the home window 402a, the search window 402b, and the project maintenance order number window 402c. Some embodiments also include the edit function 402d, which can allow documents to be attached and associated with an order in the project maintenance order number window 402c. In some embodiments, the schedule pane 810 can provide a depiction of an informational status of any particular project, such as for example the order identified by the project number window 402c. Furthermore, the schedule pane 810 can provide a milestone list 816, comprising specific milestone descriptions. The schedule pane 810 can also include an actual due date 819, a proposed due date 820, last change date 822, and an associated identifier 824. In some embodiments, a user 40 can propose a change to a due date 820, and any change to a proposed due date 820 can display as the date changed (the last change date 822), accompanied by an identification of the user 40 who made the change in the identifier 824. The schedule pane 810 can also provide a series of dates related to the schedule, including an actual finish date 826, a proposed finish date 828, a finish last change date 830, and a proposed finished last changed by 832. In some embodiments, the schedule pane 810 can also include a drop-down menu 815 offering the ability to display a number of alternative windows with the pane 810. For example, as shown in FIG. 12, the drop-down menu 815 can include access to other informational windows (displayed in place of the milestone list 816) including, but not limited to, a construction schedule 815a, an engineering schedule 815b, milestones 815c, a project maintenance order milestones 815d, and a project change order 817.

In some embodiments, a user 40 can select at least one of the other informational windows described to display alternative information. For example, a selection of the project change order 817 from the drop-down menu 815 can switch the information from pane 810 to a project change order sub-window 817a as shown in FIG. 13, which illustrates an example of a portal 850 “Schedule” of a front end module 16 according to one embodiment of the invention. In some embodiments, the project change order sub-window 817a can also enable a user 40 to access various alternative sub-windows 818 from which a user 40 can access and input data. Furthermore, a comments link 830 can also be provided to offer a user 40 the ability to access, review, and update the project record with information related to any specific changes or updates. As shown in portal 850, one of the sub-windows 818 can include operations dates 818a sub-window, providing a summary of information associated with the project change order, including, but not limited to the project change order type, a specific activity for each entry, a comments, descriptions, dates and identifiers related to the change order. In some embodiments, the project change order sub-window 817a within portal 850 can also provide access to any entries from a project manager as shown in column 818b. In some embodiments, the operations dates 818a sub-window can include information related to a project change order including a project change order number 861, item #863, and project change order type 865. As shown, associated with any specific project change order can be an activity 867, an operation number 869, a propose date 871, a propose on date 875, and a propose by 873. Furthermore, the operations dates 818a sub-window can also provide a column for commentary and comments, as well as associated project manager information. For example, the operations dates 818a sub-window can provide a reason column 877, a proposed comments 879, and a project manager comments 887, in addition to a project manager 881 column, a project manager last change 883 column, and a status 885 column.

Some embodiments of the invention can enable a user to access information related to project operations. For example, FIG. 14 provides a screenshot illustrating an example of a portal 900 “operations” of a front end module 16 according to one embodiment of the invention. In some embodiments, the portal 900 can include a main tool bar 402 including various access icons 403, and numerous function and access windows such as the home window 402a, a search window 402b, and the project maintenance order number window 402c. Some embodiments also include the edit function 402d, which can allow documents to be attached and associated with the order as shown in the project maintenance order number window 402c. In some embodiments, the operations pane 910 can provide an informational status of any particular operation within a project, such as for example the order identified by the project number window 402c. As shown in FIG. 14, the operations pane 910 can also include a summary display of operations window 915. Further, the user 40 can also have access to an hours approved box 925 in some embodiments. In some further embodiments, a user can visualize projection information in one or more Gantt charts. For example, some embodiments can include a Gantt display function 920 to enable a user 40 to prepare at least one Gantt chart style view of operations within a project.

In some embodiments, the operations pane 910 can provide an informational status of any particular operation within the operations window 915. For example, in some embodiments, the operations window 915 can include an operations identifier within the operations list 931 and a description column 933 including a description operation. The operations window 915 can also include work center 935 and a proposed or “prop” work center 937 associated with the operation, as well as scheduling information. For example, the operations window 915 can include plan hours 939, plan start 941, plan finish 943, actual start 945, actual finish 947, size 949, duration 951, unit 953, schedule 955, actual hours 957, estimated hours 959, forecast hours 961, and variance 963 information columns.

In some embodiments, a user 40 can display a sub-operation 915a. For example, FIG. 15 provides a screenshot illustrating an example of a portal 950 “operations” of a front end module 16 according to one embodiment of the invention. As shown, by selecting at least one operation within the operations information columns 916, the operations pane 910 can also include a summary display of operations 915 that can include a sub-operation 915a.

Some embodiments of the enterprise resource management system 20 can enable a user 40 to review materials and related services required for funded work. In some embodiments, the enterprise resource management system 20 can enable a user 40 to automate the materials and services requests for upcoming work once appropriate clearance is received through the enterprise resource management system 20. For example, as shown in FIG. 16, some embodiments include a portal 1000 “components” of a front end module 16 which can provide visibility to a project at the component level. As shown, the portal 1000 can include a components pane 1010 comprising a series of information columns within the components window 1015, as well as an edit components function 1020, and a components report function 1030, received and delivered status columns 1015b, and a vendor link 1015a providing direct linkage to at least one SAP® core modules, such as modules 14a, 14b.

In some embodiments, the components window 1015 can include a variety of information columns including information related to materials type, description, quantity, date required, location, and forecast delivery date, vendor information, amongst other information. For example, the components window 1015 can include material identification information quantity information including a material code 1041 and a description 1043, quantity 1045 and unit 1047 data columns. The components window 1015 can also include a required date 1049 and a location 1051, as well as information related to a bill of materials (which in some embodiments, can include a list of the raw materials, sub-assemblies, sub-components and individual parts) with the bill of materials column 1053 with an assigned bill of materials number 1055. Some embodiments can provide delivery schedule and vendor information associated with the components. For example, some embodiments include information columns including a forecast delivery 1057, received 1059, delivered 1061, as well as the associated purchase order number 1063, EMM 1065, EMM link 1067, vendor 1069, and part number 1071 information columns.

Some embodiments of the invention can enable alternative data views within the resource management system 20. For example, in some embodiments, generally any document associated with a project can be viewed regardless of the type of document. FIG. 17 for example shows a screenshot illustrating one example of a portal 1100 “documents” of a front end module 16 according to one embodiment of the invention. In some embodiments, the portal 1100 can include a pane 1110 a document information window 1115. The portal 1100 can include a main tool bar 402 including various access icons 403, and numerous function and access windows, such as the home window 402a, a search window 402b, and a project maintenance order number window 402c. Some embodiments also include the edit function 402d, which can allow documents to be attached and associated with the order as shown in the project maintenance order number window 402c. In some embodiments, the information window 1115 can include a variety of information columns including, but not limited to a listing of document names, document types, document description, a creation date and identifier column, as well as document file name information. For example, in some embodiments, the information window 1115 can include descriptive information including a document name 1131, document type 1133, a document description 1135, and a file name 1145. In some embodiments, the information window 1115 can also include a voltage column 1137, and an edrs (electronic document routing system) column 1139, as well as a create date 1141 and a created by 1143 identifier column.

Some embodiments provide further flexibility to the user 40 for increasing or minimizing information related to a specific project including any associated order. For example, FIG. 18 shows a screenshot illustrating an example of a portal 1200 “notes” of a front end module 16 according to one embodiment of the invention. Within this embodiment of the invention, a user 40 can be presented with a notes pane 1210 which can include several expandable sub-windows for presenting expanded information related to a specific project including any associated order. For example, in some embodiments, a user 40 can input and review information pertaining to notifications and to land and environmental comments. As shown in FIG. 18, the notes pane 1210 can include an order text window 1215, a notification text window 1220, and an environmental comments window 1230. Further, each window can allow an expanded region for detailed information to be displayed. Furthermore, associated with each of the windows 1215, 1220, 1230 is an expand function 1240 allowing a user 40 to toggle between more or less visible information in the windows 1215, 1220, 1230. In some embodiments, a user 40 can record comments which are then stamped with the user's assigned LAN ID, and remain a permanent record (i.e. no editing or deletion is allowed by the user). For example, in some embodiments, information entered into and displayed in windows 1215, 1220, 1230 comprises a permanent record, substantially non-erasable by a user.

As discussed earlier with respect to FIG. 4, some embodiments of the invention can provide a user 40 the ability to couple geospatial information to at least one project phase 85a, 85b, 85c, 85d, 85e of a project life cycle 83 using GIS software platform 19b. By coupling at least one GIS software platform and/or database 37 to at least of the system modules 10, a user 40 can create, manage, analyze and display real-time geospatial data, and associate one or more geospatial variables to at least one project parameter, including for example any specific project maintenance order identified in the project maintenance order number window 402c. FIG. 19 shows a screenshot illustrating an example of a portal 1300 “location” of a front end module 16 according to one embodiment of the invention. As illustrated, the portal 1300 can include a location pane 1310 including a map rendering (such as illustrated in the location guide 1315), and a tool bar 1315a for navigating one or more functions of the portal 1300. In some embodiments, the front end module 16 can extract a header address and/or a latitude and longitude parameters from at least one project maintenance order header and provide a visual marking within the location guide 1315 using geospatial information provided at least in part by the GIS module 19b. For example, the location guide 1315 can include an address pinpoint 1320 comprising a graphical element rendered and positioned onto the location guide 1315 at a position that corresponds to a header address and/or a latitude and longitude parameters extracted from a project maintenance order identified in the project maintenance order number window 402c (i.e., corresponding to a job location). In some further embodiments, links can be provided to one or more web browsers, including, but not limited to Google®. Google® and the Google Logo are registered trademarks of Google Inc. In some embodiments, the tool bar 1315a can provide the user 40 with a variety of functions to manipulate the map rendering within the location guide 1315. The functions of the tool bar 1315a can also enable a user 40 to output the contents of the location guide 1315 (e.g., by printing a copy of the map rendering within the location guide 1315 corresponding to a specific job location). In some further embodiments, the portal 1300 can enable a user 40 to control the amount of information that is shown in the location guide 1315 using one or more selectable parameters within menu 1315b.

Some embodiments enable a user 40 to review a high level summary by project number. For example, in some embodiments, a user 40 can utilize the front end module 16 to access and create an overall view of a project as referenced by a project number imported from the project management module 12. FIG. 20 for example shows a screenshot illustrating an example of a portal 1400 “hierarchy” of a front end module 16 according to one embodiment of the invention. In some embodiments, the portal 1400 can include a hierarchy window 1412, a main tool bar 402 including various access icons 403. Further, the portal 1400 can include numerous function and access windows, such as the home window 402a, a search window 402b, and the project maintenance order number window 402c. In some embodiments, an overall view of a project's components can be displayed within the hierarchy window 1412, displaced for instance by project number, planning order, and project maintenance order. In some embodiments, the hierarchy window 1412 can include an order hierarchy 1412a, as well as a description 1412b. In some embodiments, specific project maintenance orders can be opened in new project maintenance order number windows 402c by selecting (for instance by double clicking) on the project maintenance order 1415.

Some embodiments of the invention enable a user 40 to access a variety of project related financial information. For example, in some embodiments of the front end module 16, a user 40 can view project maintenance order financial data, or construction cost data, including, but not limited to authorized amounts and estimated amounts maintained by project management. FIG. 21 for example shows a screenshot illustrating an example of a portal 1500 “financial” of a front end module 16 according to one embodiment of the invention. In some embodiments, the portal 1500 can include a main tool bar 402 including various access icons 403, and numerous function and access windows, such as the home window 402a, a search window 402b, and a project maintenance order number window 402c. In some embodiments, financial information can be displayed in the portal 1500, which in some embodiments can include financial figures 1515 displayed within a financial window 1512. In some embodiments, the financial window 1512 can be configured to provide a construction financial data to one or more users 40 involved with a construction phase 85d of a project. In some embodiments, the financial window 1512 can also include a drop-down menu 1514 to enable a user 40 to select other financial data for display within the financial window 1512. In some further embodiments, a user 40 can view construction financial data for a project maintenance order. In some other embodiments, a user 40, governed by a specific role, can edit construction financial data for a project maintenance order.

Some embodiments can allow a user 40 to enter and to search for miscellaneous data related to a project maintenance order. For example, in some embodiments, the front end module 16 can include another pane 1610 that can display miscellaneous data related to a project maintenance order. For example, FIG. 22 shows a screenshot illustrating an example of a portal 1600 “other” of a front end module 16 that can include another pane 1610. In some embodiments, the other portal 1600 can include a main tool bar 402 including various access icons 403, numerous function and access windows, such as the home window 402a, search window 402b, and the project maintenance order number window 402c. In some embodiments, the other pane 1610 can include at least one editable field. For example, as shown in FIG. 22, some embodiments can include free form fields 1615. In some embodiments, the free form fields 1615 can include editable fields, including for example construction fields, civil fields rank, and special program fields. In some embodiments, a user 40 can use free form data that can include searchable text.

In some embodiments, the enterprise resource management system 20 system implemented within the architecture 30 as described can enable one or more users 40 to receive, analyze, input, modify, create and send forecast data. For example, FIG. 23 shows a screenshot illustrating an example of a portal 1700 “resource allocation” of a front end module 16 according to one embodiment of the invention. As shown, the portal 1700 can include a main tool bar 402 including various access icons 403, numerous function and access windows, such as the home window 402a, search window 402b, and the project maintenance order number window 402c. In some embodiments, the portal 1700 can also include a resource allocation pane 1710. In some embodiments, resource allocation pane 1710 can further include a resource allocation window 1715 providing at least a partial summary of data related to resource allocation.

The resource allocation window 1715 can also provide information related to specific orders. For example, in some embodiments, the resource allocation window 1715 can include order column 1751 that can be displayed along with operation 1753, WC (work center) 1755, ACT (activity) type 1757, responsible 1759 and a total 1761 information columns. Furthermore, the resource allocation window 1715 can include forecast data 1720 and operations summary data 1730, with data lists viewable by hours or resources by accessing a view mode toggle 1735. In some embodiments, the forecast data 1720 can comprise data from the project management module 12. In some embodiments, the forecast data 1720 can be color highlighted (for instance highlighted in a yellow color). In some further embodiments, the operations summary data 1730 can comprise data from the front end module 16. In some embodiments, the operations summary data 1730 can be color highlighted (for instance highlighted in a green color). Some embodiments can also include a resource allocation window 1715 comprising a lower section 1715a. In some embodiments, the lower section 1715a can display totals for all selected orders selected from the resource allocation window 1715. In some embodiments, a user 40 can allocate resources by assigning hours to the resource allocation window 1715. In some embodiments, a user 40 can select a work center from the work center drop-down menu 1740, and can enter hours into at least one row of the forecast data 1720 and operations summary data 1730.

In some embodiments, at least some data and/or fields of data (including for example data within any one of the portals 400, 500, 600, 650, 700, 800, 850, 900, 950, 1000, 1100, 1200, 1300, 1400, 1500, 1600, 1700, 1800, and 1900, and/or with any one of the portals 2000, 2100, 2200, 2300, 2400, 2500, 2600, 2700, 2800, 2900, 3000, 3100, 3200, 3300, 3400 within one or more of the enterprise resource management system modules 10 can be dynamically linked (i.e. synchronized) with at least one database 37. As used herein, dynamically linked can comprise an update of at least one portion of the portals 400, 500, 600, 650, 700, 800, 850, 900, 950, 1000, 1100, 1200, 1300, 1400, 1500, 1600, 1700, 1800, and 1900, 2000, 2100, 2200, 2300, 2400, 2500, 2600, 2700, 2800, 2900, 3000, 3100, 3200, 3300, 3400 that can cause at least one processor 32 to update at least a portion of the portal or one or more other portals 400, 500, 600, 650, 700, 800, 850, 900, 950, 1000, 1100, 1200, 1300, 1400, 1500, 1600, 1700, 1800, and 1900, 2000, 2100, 2200, 2300, 2400, 2500, 2600, 2700, 2800, 2900, 3000, 3100, 3200, 3300, 3400. For example, in some embodiments, dynamical linking can comprise the system modules 10 coupled to at least one data source and/or data storage system comprising one or more database 37, that can be configured to send and receive data from at least one database 37 (that can comprise at least one data storage 37b, and/or at least one data source 37a). The system modules 10 can be configured to receive data from at least one other source (e.g., as input data 39), and can be configured within the enterprise resource management system 20 to provide output data 25 to a user 40 that can include updating at least one of the portals 400, 500, 600, 650, 700, 800, 850, 900, 950, 1000, 1100, 1200, 1300, 1400, 1500, 1600, 1700, 1800, and 1900, and/or with any one of the portals 2000, 2100, 2200, 2300, 2400, 2500, 2600, 2700, 2800, 2900, 3000, 3100, 3200, 3300, 3400. In most embodiments, any update of any one of the aforementioned dynamically linked portals can occur within 0.5 seconds or less.

In some embodiments, information can be viewable within the resource allocation pane 1710 from multiple project maintenance orders. Further, some embodiments provide a user 40 (for example a supervisor) the option of forecasting hours and allocation of personnel. For example, in some embodiments, a supervisor can utilize the allocation pane 1710 to allocate crew resources for any specific project maintenance order. In some other embodiments, individual personnel (supervisory or non-supervisory) can allocate their own resource time. In some embodiments, the resource allocation pane 1710 can be used for managing inventory. For example, in some embodiments, at least some data and/or fields of data (including for example data within any one of the portals 400, 500, 600, 650, 700, 800, 850, 900, 950, 1000, 1100, 1200, 1300, 1400, 1500, 1600, 1700, 1800, and 1900, and/or with any one of the portals 2000, 2100, 2200, 2300, 2400, 2500, 2600, 2700, 2800, 2900, 3000, 3100, 3200, 3300, 3400 within one or more of the enterprise resource management system modules 10, including for example any data displayed with the resource allocation pane 1710) can be dynamically linked (i.e. synchronized) with a database 37 that comprises supply data related to an inventory (e.g., an inventory of materials or other supplies). In some embodiments, synchronization can occur substantially simultaneously, or at least within 0.5 seconds or less.

Some embodiments of the invention can be accessible by one or more users 40 that can comprise personnel with different job functions. In some embodiments, one or more users 40 can be assigned different job responsibilities through one or more phases within a project life cycle 83, including for example, at least a planning phase 85a, an engineering phase 85b, a staging phase 85c, a construction phase 85d, and a closeout phase 85e. As described earlier, in general, when initiating a new project, a project manager (i.e. one type of user 40) would be assigned to a project, and the project manager would utilize the project management module 12 and to create a detailed project schedule. In some embodiments, at least one of the modules 10 can include at least one portal dedicated to a user 40 that can include a project manager. Some embodiments of the invention provide one or more of the system modules 10 that can be configured specifically to interface with a plurality of other system modules 10, or other programs or data sources to report data to a user 40 including a project manager. Furthermore, some embodiments of the invention provide one or more system modules 10 that can be configured specifically to report forecast data to a user 40. For example, FIGS. 24-30 shows various screenshots illustrating examples of various portals related to forecasting as displayed by the front end CAEPS reporting module 18a. In some embodiments, the various portals as illustrated in FIGS. 24-30 can include at least one portal dedicated to a user 40 that can include a project manager.

FIG. 24 for example shows a screenshot illustrating an example of a portal 1800 “forecasting—target versus plan” of a front end CAEPS reporting module 18a according to one embodiment of the invention. As shown, the portal 1800 can include a main tool bar 1802 including various access icons 1803, numerous function and access windows, such as the home window 1802a, a plans window 1802b and 1802c, and the project maintenance order number window 402c. Some embodiments can also include an information window 1820 including at least one other sub-window. For example, in some embodiments, the information window 1820 can include an available assembly list 1824 comprising at least one available assembly 1824a, and a planned assemblies list 1826 comprising at least one planned assembly 1826a. As shown, cost information for assemblies can be displayed to a user 40 as a function of quantity 1826a and hours 1826b. Further, in some embodiments, the cost information 1827 can include a total 1827d that can be displayed as data related to labor 1827, material 1827b, and other costs 1827c.

Some embodiments can also include at least one data display chart rendered within the information window 1820. Some embodiments provide a user 40 (for example a project manager) to build the planned assemblies list 1826 from the available assembly list 1824. For example, in some embodiments, the available assembly list 1824 can be built by a user 40 selecting an available assembly from the available assembly list 1824, dragging the available assembly from the available assembly list 1824, and dropping the available assembly into the planned assemblies list 1826. For example, in some embodiments, a user 40 can move any selected assembly within the available assembly list 1824 to the planned assemblies list 1826. In this instance, the planned assemblies list 1826 (including for example the information 1826a, 1826b, 1827a, 1827b, 1827c and/or 1827d) can be updated by at least one of the resource management system modules 10.

In some embodiments, a user 40 can use the portal 1800 to prepare forecasted data. For example, in some embodiments, a user 40 can compare costs to target based on tasks (such as assemblies, including for example at least one assembly 1824a, 1826a). For example, some embodiments can include a target forecast. In some embodiments, a target forecast can comprise a target versus plan chart 1828 that can include a rendered chart at least partially based on data displayed in either of the available assembly list 1824, and a planned assemblies list 1826. In some embodiments, as a planned assemblies list 1826 is built, a target versus plan chart 1828 can be rendered. The target versus plan chart 1828 can include at least a plot representing plan data 1828a and target data 1828b. In some embodiments, when a plan data 1828a meets a target specification, the plan data 1828a can be rendered in green, or some other color representing a plan data 1828a that is within a specification. In some further embodiments, portal 1800 can be used to establish a total cost to build. In other embodiments, the portal 1800 can be used to provide insight into responsibility for one or more costs associated with a specific plan.

Some further embodiments can provide a user 40 the ability to track capital and costs for project maintenance orders that can be within a specification, or out of specification. For example, FIG. 25 shows a screenshot illustrating an example of a portal 1900 “forecasting—capital versus cost” of a front end CAEPS reporting module 18a according to one embodiment of the invention. As shown, the portal 1900 can include at least one financial planning window 1920 with data columns 1925 including a last saved 1928 column, along with a spec status 1930, as well as a submit function 1929, approve function 1931, and load function 1932. In some embodiments, the data columns 1925 can include an order column 1925, a description 1925b, and associated division 1925c. In some embodiments, financial forecasting data can include target cost 1926 and plan cost 1927 financial data including baseline 1926a and adjusted 1926b target dollars, along with baseline 1927a and adjusted 1927b plan dollars.

In some embodiments, based on information shown in the target versus plan chart 1828 in portal 1800, portal 1900 can display target and plan costs within the data columns 1925 related to specific orders, including a spec status 1930. In some embodiments, the spec status 1930 can be highlighted in colors to provide a visual indicator based on legends comprising a plan under spec 1930a, a plan in spec 1930b, plan over target 1930c. For example, in some embodiments, the spec status 1930 can be highlighted in colors to provide a visual indicator of the plan under spec 1930a, plan in spec 1930b, plan over target 1930c status. For example, in some embodiments, a specification or “spec” status 1930 can be highlighted yellow to indicate plan under spec 1930a, and highlighted green to indicate a plan in spec 1930b, and highlighted red to indicate a plan over target 1930c.

Some embodiments can also provide capacity (i.e., a representation of a resource) versus demand (i.e., a plan) and prepare capacity versus demand scenarios. For example, FIG. 26 shows a screenshot illustrating an example of a portal 2000 “forecasting—capacity versus demand” of a front end CAEPS reporting module 18a according to one embodiment of the invention. In some embodiments, the portal 2000 can include a capacity vs. demand window 2010, a resource leveling window 2020, a capital window 2060, and an expense window 2065. Further, in some embodiments, each of the capital window 2060 and expense windows 2065 can include planned hours and actual hours forecasting information. For example, the capital window 2060 can include an MWC group/MWC 2060a column along with associated planned hours 2060b and actual hours 2060c information, and the expense window 2065 can include a MWC group/MWC 2065a column with planned hours 2065b and actual hours 2065c.

In some embodiments, the portal 2000 can include one or more capacity versus charts for a current or future forecast year. For example, in some embodiments, the portal 2000 can include a capacity versus demand chart 2030 (in this instance showing capacity versus demand data for a current year), and a capacity versus demand scenario chart 2040 (in this instance showing a capacity versus demand data for a future year). In some embodiments, charts 2030, 2040 can each include a demand curve 2050a and a capacity curve 2050b. In some embodiments, the demand scenario chart 2040 can include a demand slider 2055 which can be associated with an adjusted demand type 2055a. In some further embodiments, the capacity versus demand scenario chart 2040 can be used to plot various capacity versus demand scenarios based on an adjusted demand controlled by the demand slider 2055. For example, the capacity versus demand scenario chart 2040a shown in the portal 2400 illustrated in FIG. 30 can include an adjusted demand curve 2050c that represents an adjusted demand. In some embodiments, the portal 2400 can also include a resource type drop-down menu 2005 for selection of resource type for capacity versus demand planning. Further examples illustrating capacity versus demand analysis can be seen in FIGS. 27-29 illustrating portals 2100, 2200, and 2300 respectively, and showing capacity versus demand charts 2030 and capacity versus demand scenario charts 2040 for several different selections of resource type.

Some embodiments of the enterprise resource management system 20 can include additional portals to assist in managing project resources. For example, some embodiments can provide schedule versus capacity information to enable a user 40 (for example, a project manager) to gain an understanding of the scheduled hours against resource capacity for an upcoming project period (e.g., by looking forward into a 2, 6 or a 12 week period). For example,

FIG. 31 shows a screenshot illustrating an example of a portal 2500 “schedule versus capacity” of a CAEPS reporting module 18a according to one embodiment of the invention. As shown, the portal 2500 can include a main tool bar 1802 including various access icons including a report selection drop-down menu 2520 comprising a selection of parameters that can be selected for display. In some embodiments, a schedule versus capacity summary can be displayed in the summary window 2515, while full details of the schedule versus capacity can be viewed in the detail window 2540. For example, in some embodiments, a user 40 can select schedule vs. capacity metrics 2520a. FIG. 32 shows a screenshot illustrating an example of a portal 2600 “schedule versus capacity” of a front end CAEPS reporting module 18a module according to one embodiment of the invention. The portal 2600 can include a schedule versus capacity window 2610 comprising a summary window 2515, and a detail window 2540. The detail window 2540 can include a variety of information related to scheduling and capacity. For example as shown in FIGS. 31 and 32, detail window 2540 can include the location/MWC/MAT 2545, resource type 2547 and work type 2549, order 2551 and order short text 2553, a job owner 2555, as well as estimated hours 2557 and scheduled hours 2559 data columns. In some embodiments, the summary window 2515 can include various schedule versus capacity statistics including scheduled work 2620, capacity (boots on ground) 2625 and % schedule full 2630. In some embodiments, a user 40 can access full details of any summary window 2515 within the detail window 2540.

FIGS. 33-34 show additional screenshots illustrating examples of portals related to “schedule versus capacity” of a front end CAEPS reporting module 18a module according to one embodiment of the invention. In some embodiments, schedule versus capacity data can be viewed in various formats with alternative levels of detail. For example, FIG. 33 shows a screenshot illustrating an example of a portal 2700 providing schedule versus capacity data including various informational windows including division overview 2720, weekly 2725, and % schedule full trend 2730. As shown, the division overview 2720 can provide a variety of scheduling and capacity information. For example, work type 2725a and division 2725b information can be provided and along with the associated electric construction 2726, gas construction 2727, and electric and gas construction 2728 scheduling and capacity data columns. As shown in FIG. 33, the weekly 2725 information window can be configured to display electric construction 2726 information including schedule 2726a, capacity 2726b, and % schedule full 2726c. Further, the weekly 2725 information window can also be configured to display gas construction 2727, schedule 2727a, capacity 2727b, and % schedule full 2727c. Moreover, in some embodiments, the weekly 2725 information window can also be configured to display electric and gas construction 2728 information including schedule 2728a, capacity 2728b, and % schedule full 2728c data columns. FIG. 34 shows a screenshot illustrating an example of a portal 2800 “schedule versus capacity metrics” of a front end CAEPS reporting module 18a showing a % schedule full trend 2730 window. In some embodiments, a user 40 can select various parameters from the pull-down menus 2740 in order to alter the data displayed in the % schedule full trend 2730 window.

Some embodiments of the enterprise resource management system 20 can include additional portals to assist in viewing and managing project resources. For example, some embodiments can provide a user 40 the ability to track plan hours and actual hours for any specific project, and monitor plan against actual work executed and available work. As shown in FIG. 35, the enterprise resource management system 20 can be capable of displaying a portal 2900 “plan versus actual data” of a front end CAEPS reporting module 18a including a plan vs actual window 2910 with a plan hours information window 2915. In some embodiments, plan hours information window 2915 can be configured to display plan versus actual plan hours filtered through one or more filters 2920. In some embodiments, plan hours information window 2915 can be configured to display project orders 2915a, and in some embodiments at least some hours data displayed in the plan hours information window 2915 can be placed in various categories provided in the plan legend 2930 by displaying a color code associated with each category. For example, as illustrated in FIGS. 35 and 36, in some embodiments, the category 2930a, category 2930b, category 2930c, and category 2930d can be included. In some embodiments, the category 2930a can correspond to Actual>plan or % is over 100 for % actual to plan, actual+available work>plan or % is over 100 for % of actual+available work to plan, and actual+schedule is >plan or % is over 100 for % of actual+schedule to plan. In some further embodiments, category 2930b can correspond to % is <=100 and >% complete. In some further embodiments, category 2930c can correspond to % is >30% of % complete and <=% complete for % actual to plan, and % is >30% and <=100 for % of actual+available work to plan, and % is >30% and <=100 for % of actual+schedule to plan. In some further embodiments, category 2930d can correspond to % is <=30% of the % complete for % actual to plan, % is <=30% for % actual+available work to plan, and % is <=30% for % of actual+schedule to plan.

In some embodiments, plan hours information window 2915 can also be configured to display additional plan versus actual data associated with the display project orders 2915a. For example, in some embodiments, the plan hours information window 2915 can display planned hours 2940, actual hours 2942, remaining hours 2944 and % actual to plan 2946 information columns. Some embodiments can include a readily available 2950 category, including work in hand hours 2950a and dispatched hours 2950b information columns. As shown, some embodiments also include % of actual+available work to plan 2955, scheduled hours 2957, as well as % of actual+scheduled to plan 2959 information columns.

In some embodiments, the plan hours information window 2915 can also be configured to display plan versus actual plan hours filtered through one or more filters 2920 for sub-categories 3020. FIG. 36 for example shows a screenshot illustrating an example of a portal 3000 “plan versus actual data” of a front end CAEPS reporting module 18a illustrating a plan hours information window 2915 including the display of hours related to sub-categories 3020.

Some embodiments of the enterprise resource management system 20 can include other portals to provide further assistance to a user 40 in viewing and managing project resources. For example, some embodiments can provide a user 40 the ability to manage resource leveling of track plan hours and actual hours for any specific project, and monitor plan against actual work executed and available work. FIG. 37 shows a screenshot illustrating an example of a portal 3100 “resource leveling” of a front end CAEPS 18a reporting module according to one embodiment of the invention. As shown, the portal 3100 can include a main tool bar 1802 including various access icons including a resource leveling window 3115 including filters 3117. In some embodiments, a user 40 can display resource leveling information in a desired format using a series of icons including for example, the table icon 3120, chart icon 3122, or details icon 3124. In some embodiments, the user 40 can select the table icon 3120 to display a plan vs. capacity table 3120a (shown in FIG. 38), or a chart icon 3122 to display actual versus capacity chart 3122a. In some embodiments, filters 3122b can be selected, for example to change the timeframe of the plan versus actual data displayed in the actual versus capacity chart 3122a. As shown in FIG. 37, the actual versus capacity chart 3122a can include various plan versus actual capacity data including, but not limited to, plan hours 3130, actual DT hours 3132, actual OT hours 3134, actual ST hours 3136, remaining plan hours 3138, potential contract hours 3140, overtime times 3142, and ST billed hours 3144. As shown in FIG. 38, showing an example of portal 3200, by selecting the table icon 3120, a plan vs. capacity table 3120a can be displayed and filtered using table filters 3120b. As shown, the table filters 3120b can include a timeframe drop down menu 3121a for varying the date range applied to the displayed in the plan vs. capacity table 3120a. Resources can be adjusted using the FTE adjust function 3121b and the reset OT %/contract function 3121c, and overtime and contract resources displayed using the potential overtime/contract hours 3121d function.

In some embodiments, a user 40 can access and review assumptions used to perform resource leveling for display in portals 3100, 3200 as described. For example, FIG. 39 shows a screenshot illustrating an example of a portal 3300 “resource leveling” of a front end CAEPS reporting module 18a according to one embodiment of the invention. In some embodiments as shown, an assumptions report window 3320 can be displayed to provide a user 40 with a description summary of the assumptions applied to resource leveling functions. This can include general resource information, and information related to capacity basis (set by administrator), capacity, and demand.

In some embodiments, the enterprise resource management system 20 can provide visibility to materials and materials services required for funded work and automate the materials and services requests for upcoming work once appropriate clearance is received through the enterprise resource management system 20. Moreover, in some embodiments, the enterprise resource management system 20 can show material quantity demand forecast based on plan, assess and display unplanned inventory and changes in unplanned inventory, and show inactive and unplanned inventory. Some embodiments also provide the ability to compare contracted (labor) rates and associated year-on-year changes. FIG. 40 for example shows a screenshot illustrating an example of a portal 3400 “supply chain” of a front end CAEPS reporting module 18a according to one embodiment of the invention. As shown, the portal 3400 can display a supply chain window 3410 including a material records window 3415. In some embodiments, one or more materials variables displayed in the material records window 3415 can change based on selection of one or more filters 3420. For example, the material records window 3415 displaying a material code 3431 and a description 3433, can also display the spending category 3435, monthly quantities 3437 and total 3439 for all the materials within the material code 3431.

The above-described databases and models throughout enterprise resource management system architecture 30 and enterprise resource management system module integration 50 can store analytical models and other data within the databases 37 on computer-readable storage media 36. In addition, the above-described applications of the system architecture 30 and system module integration 50 can be stored on computer-readable storage media 36, including within any portion of the database 37. With the above embodiments in mind, it should be understood that the invention can employ various computer-implemented operations involving data stored in one or more computer systems, including for example the computing device 31. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The processes and method steps performed within the enterprise resource management system architecture 30 including the enterprise resource management system module integration 50 cannot be performed in the human mind or derived by a human using pen and paper, but require machine operations to process input data to useful output data. For example, the processes and method steps performed within the enterprise resource management system architecture 30 including the enterprise resource management system module integration 50 can include a computer-implemented method comprising steps performed by at least one processor 32, operable within at least one computing device 31.

The invention also relates to a device or an apparatus for performing these operations. The apparatus can be specially constructed for the required purpose, such as a special purpose computer (i.e., in some embodiments, the computing device 31 can be constructed for a special purpose). When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources.

The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage, or in particular formats that enable the construction or depiction of a physical and tangible object. In some embodiments, the manipulation can be performed by at least one processor 32. In such an example, the at least one processor 32 thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and can include without limitation volatile and non-volatile, removable and non-removable storage media implemented in any method or technology for the tangible storage of information such as computer-readable instructions, data structures, program modules or other data.

Although method operations may be described in a specific order, it should be understood that other housekeeping operations may be performed in between operations, or operations may be adjusted so that they occur at slightly different times, or may be distributed in a system which can allow the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the invention.

1. A computer-implemented method of managing enterprise resources, comprising:
providing a plurality of process modules for managing resources within a project life cycle associated with a plurality of processes, at least one of the modules using at least one processor to access a database stored on a non-transitory computer-readable storage medium, the plurality of process modules including:
a project and asset management module for managing at least a plurality of assets and regulating executable work for at least some of the plurality of projects;
a program management module for managing a substantially fully resourced schedule stored on a non-transitory computer-readable storage medium for at least some of the plurality of projects;
a resource and scheduling module for maintaining a resource database stored on a non-transitory computer-readable storage medium and scheduling resources for at least some of the plurality of projects;
a planning and reporting module for planning and reporting upon at least some of the plurality of projects;
an engineering design module for designing at least some of the plurality of projects;
an interface module that uses at least one of the processors to interface at least two of the plurality of modules; and
using at least the project and asset management module for long-term planning and defining at least one project work item in the project life cycle.

2. The computer-implemented method of managing enterprise resources of claim 1, wherein the program management module is configured and arranged to maintain a schedule of at least one project work item during the project life cycle.

3. The computer-implemented method of managing enterprise resources of claim 1, wherein the at least one project work item is automatically scheduled within the resource and scheduling module.

4. The computer-implemented method of managing enterprise resources of claim 3, wherein all work impacting a construction phase of the project life cycle including any impact on construction can be reviewed by construction management using the resource and scheduling module.

5. The computer-implemented method of managing enterprise resources of claim 1, wherein the resource and scheduling module provides at least one of a resource management function, a Gantt chart function and a capacity summary function to provide resource loading information to a user.

6. The computer-implemented method of managing enterprise resources of claim 1, wherein the interface module includes informational summary panes for providing information on a least one of the plurality of projects, the informational summary panes including at least one of a status pane, a team pane, a tasks pane, a drawings pane, a schedule pane, an operations pane, a components pane, a documents pane, a notes pane, a location pane, a hierarchy pane, a financial pane, an other pane, and a forecast pane.

7. The computer-implemented method of managing enterprise resources of claim 1, further comprising a GIS module.

8. The computer-implemented method of managing enterprise resources of claim 7, wherein the GIS module is coupled to at least the interface module for identifying an address pinpoint corresponding to a job location of at least one project work item.

9. The computer-implemented method of managing enterprise resources of claim 6, wherein location pane includes at least one a map rendering at least partially illustrating a map that includes an address pinpoint corresponding to a job location of the at least one project work item.

10. The computer-implemented method of managing enterprise resources of claim 10, wherein at least one of the information summary panes includes at least one data field dynamically linked to at least one of the plurality of modules.

11. The computer-implemented method of managing enterprise resources of claim 10, wherein at least one of the information summary panes includes at least one data field dynamically linked to at least one warehouse management system module.

12. The computer-implemented method of managing enterprise resources of claim 10, wherein at least one of the information summary panes includes at least one data field dynamically linked to at least the program management module and the resource and scheduling module.

13. The computer-implemented method of managing enterprise resources of claim 6, wherein at least one of the information summary panes includes at least one audit history that is substantially non-erasable by a user.

14. The computer-implemented method of managing enterprise resources of claim 1, wherein the interface module includes an informational summary pane comprising a resource allocation pane, the resource allocation pane providing access to at least one of forecast data and operations summary data of the at least one project work item.

15. The computer-implemented method of managing enterprise resources of claim 14, wherein the resource allocation pane includes at least one data field dynamically linked to at least one database comprising an inventory of materials or supplies.

16. The computer-implemented method of managing enterprise resources of claim 1, wherein at least some portion of the at least one project work item comprises at least one available or planned assembly.

17. The computer-implemented method of managing enterprise resources of claim 1, wherein the planning and reporting module includes an information window comprising at least one available assembly list and at least one planned assembly list.

18. The computer-implemented method of managing enterprise resources of claim 17, wherein at least a portion of the project life cycle includes a target versus plan forecast based at least in part on at least one assembly selected from at least one of an available assembly list and a planned assemblies list.

19. The computer-implemented method of managing enterprise resources of claim 1, wherein the planning and reporting module includes at least one financial planning window, the at least one financial planning window including financial forecasting data comprising target cost and plan cost.

20. The computer-implemented method of managing enterprise resources of claim 19, wherein the target cost comprises baseline and adjusted target dollars and the plan cost comprises baseline and adjusted plan dollars.

21. The computer-implemented method of managing enterprise resources of claim 1, wherein the planning and reporting module includes capacity versus demand reporting comprising at least one of a resource leveling window and a capital window and an expense window.

22. The computer-implemented method of managing enterprise resources of claim 21, wherein the planning and reporting module includes plan versus actual reporting.

23. The computer-implemented method of managing enterprise resources of claim 21, wherein the planning and reporting module includes resource leveling comprising at least one of a demand curve and a capacity curve.

24. The computer-implemented method of managing enterprise resources of claim 21, wherein the planning and reporting module further includes a demand scenario chart comprising an adjusted demand.

25. A computer program product comprising: a non-transitory computer readable storage medium having computer readable program code embodied therewith, the computer readable program code comprising a plurality of process modules for managing resources within a project life cycle associated with a plurality of processes, the computer readable program code, which when loaded and run in a computer processor, causes the processor to:
provide a project and asset management module for managing at least a plurality of assets and regulating executable work for at least some of the plurality of projects;
provide a program management module for managing a fully resourced schedule stored on a non-transitory computer-readable storage medium for at least some of the plurality of projects;
provide a resource and scheduling module for maintaining a resource database stored on a non-transitory computer-readable storage medium and scheduling resources for at least some of the plurality of projects;
provide a planning and reporting module for planning and reporting upon at least some of the plurality of projects;
provide an engineering design module for designing at least some of the plurality of projects;
provide an interface module that uses at least one processor to interface at least two of the plurality of modules to define at least one project work item in the project life cycle, and to maintain a schedule of the least one project work item during the project life cycle; and
wherein the least one project work item is automatically scheduled within the resource and scheduling module.

26. An enterprise resources management system, the system comprising: a processor; a non-transitory computer-readable storage medium in data communication with the processor, the non-transitory computer-readable storage medium including a plurality of process modules executable by the processor, and configured to: manage resources within a project life cycle associated with a plurality of processes by performing the steps executable by the processor comprising:
providing a project and asset management module for managing at least a plurality of assets and regulating executable work for at least some of the plurality of projects;
providing a program management module for managing a fully resourced schedule stored on a non-transitory computer-readable storage medium for at least some of the plurality of projects;
providing a resource and scheduling module for maintaining a resource database stored on a non-transitory computer-readable storage medium and scheduling resources for at least some of the plurality of projects;
providing a planning and reporting module for planning and reporting upon at least some of the plurality of projects;
providing an engineering design module for designing at least some of the plurality of projects;
providing an interface module that uses the at least one processor to interface at least two of the plurality of modules to define at least one project work item in the project life cycle, and to maintain a schedule of the least one project work item during the project life cycle; and
wherein the least one project work item is automatically scheduled within the resource and scheduling module

27. The enterprise resources management system of claim 26, wherein the interface module uses the at least one processor to calculate and display at least one informational summary panes including at least one of a status pane, a team pane, a tasks pane, a drawings pane, a schedule pane, an operations pane, a components pane, a documents pane, a notes pane, a location pane, a hierarchy pane, a financial pane, an other pane, and a forecast pane.
